(19) United States
(12) Patent Application Publication
(10) Pub. No.: US 2011/0036653 A1
(43) Pub. Date: Feb. 17, 2011

(54) Internal combustion rotary engine with intermeshing rotors

(76) Inventor: Clyde Platt, Crittenden, KY (US)

Correspondence Address: R. CHRISTIAN MACKE, 40 EAST 10TH STREET, NEWPORT, KY, 41071, US

(21) Appl. No.: 12/462,914

(22) Filed: Aug. 11, 2009

(51) Int. Cl. B60W 10/06; F02B 53/00; F02B 33/00; F01N 3/02; B60W 20/00

(52) U.S. Cl. 180/65.28; 123/246; 123/559.1; 60/317; 180/65.21

(57) ABSTRACT

A rotary internal combustion engine having multiple intermeshing rotors. Six radial lobes and six radial voids on the uniform rotors intermesh to form sealed volumes that are then compressed as the rotors rotate. The sealed volume is compressed into bevel chambers formed between the intermeshing rotors, and fuel injectors are positioned to inject fuel when the volume is under maximum compression and to maximize combustion. The combustion products are then exhausted as the rotors continue to rotate. An external supercharger compresses air prior to its introduction into the engine to increase the compression ratio. The supercharger also communicates pressurized air into the radial voids after exhaustion to purge any remaining combustion products.

### FIELD OF THE INVENTION

This invention relates to an internal combustion engine having intermeshing rotors wherein compression and combustion occur between the rotors to drive a mechanical output.

### BACKGROUND OF THE INVENTION

Internal combustion engines are well known wherein a volume of combustible fuel is compressed and ignited to drive a mechanical device such as a shaft or piston. Much of the industrial and manufacturing evolution since the 19^{th} century has resulted from the use of internal combustion engines in myriad forms. The single most identifiable use of internal combustion engines is in self propelled vehicles, such as cars, buses, motorcycles, construction equipment, etc.

Internal combustion engines generally compress a volume of either air or a mixture of combustible fuel and air and, when sufficiently compressed, ignite the mixture to cause a chemical reaction/explosion which forces the mechanical compressing device to move in the opposite direction. This is translated into a mechanical output by, for example, an automobile driving a mechanical linkage that turns an output shaft. In that typical example of a multi-cylinder automobile, there are multiple cylinders that each have a piston that travels therein. The pistons move through a downstroke, during which fuel or air or both are brought into and contained in the cylinder. The piston then is caused to go through an upstroke during which the fuel or air or both is compressed. Next, ignition of the fuel occurs, either through the action of a spark plug (in non diesel engines) or merely by introducing fuel into the compressed (and heated) air (in diesel engines). The ignition causes the explosion in the cylinder, and the expansion of the volume therein, to push the piston back down in the power stroke. Next, the piston goes through another upstroke to push out the combustion products as exhaust. The process then repeats itself. In such multiple cylinder internal combustion engines, the pistons are all tied together through a mechanical linkage to drive a mechanical output shaft which drives, through a transmission, the wheels of the vehicle.

Another form of internal combustion engine well known in the art is the rotary internal combustion engine. In a rotary engine, an elliptical device generally travels around the periphery of a contained volume, creating volumes of compressed fuel that are sequentially ignited to push the elliptical device along its path, with provisions for exhausting the combustion products as well. Examples are found in U.S. Pat. Nos. 2,988,065 to Wankel and 3,908,608 to Fox. The output of rotary engines is generally an output shaft that is secured to the elliptical device that is pushed around its rotary path. Rotary engines operate similarly to piston/cylinder engines in that they provide for compression and combustion of a volume of fuel or air or both which, when ignited, drives the mechanical output and elliptical device.

In both rotary internal combustion engines and non-rotary internal combustion engines, diesel fuel is necessarily compressed in a larger amount than non-diesel fuel. The use of diesel fuel does not require ignition, with the fuel being added to the compressed air and immediately igniting because of the greater compression and raised temperature of the compressed air. Diesel engines require a greater compression of air, typically on the order of 19:1 to 21:1 compression ratios, while non-diesel engines using gasoline require 8:1 to 12:1 compression ratio and propane engines require compression ratios of only 2:1 or more for combustion.

Another example of internal combustion engines is the multiple rotor engine wherein volumes of fuel or air or both are captured and ignited to drive a rotary device. In some multiple rotor internal combustion engines, compression also occurs prior to combustion, such as in U.S. Pat. No. 4,003,349 to Habsburg-Lothringer. In the Habsburg-Lothringer patent and other examples of multiple rotor rotary engines, the rotors have multiple lobes forming volumes between the lobes that are filled with fuel, then compressed, ignited and exhausted.

Multiple rotor rotary engines include both examples wherein the rotors are identical, such as the Halsburg-Lothringer patent, and examples wherein the rotors are different, such as U.S. Pat. No. 4,023,917 to Klemm.

In the multiple rotor rotary engines wherein compression occurs if the rotors are designed such that a volume is created between them and sealed, trapping air or fuel or both in the sealed volume. Continued rotation of the rotors then compresses the sealed volume, and the fuel/air controls thereof. When the volume is sufficiently compressed, ignition is initiated by either spark or introduction of fuel (diesel engines). The timing of the ignition in a multiple rotor rotary engine will be near dead center so that the combustion will push the rotors in the proper direction.

In multiple rotor rotary internal combustion engines wherein compression occurs, maximum efficiency is achieved when the sealed volumes are completely sealed, such that no leakage of the volume occurs. That is, the rotors are mounted within a housing, with rotary shafts riding in or extending through sealed bearings. The sealed bearings are typically mounted in end plates of the housing. To prevent leakage of the volume being compressed it is necessary to seal off the volume before compression begins. Supplying properly shaped lobes is a necessity to provide for sealed volumes between the rotors to create the required sealing.

The prior art multiple rotor rotary engines are deficient in a number of ways compared to the present invention. It is desirable to provide a multiple rotor arrangement wherein the lobes of the rotors correspond geometrically through interlocking ovoidal lobes that seal and compress volumes formed therebetween but do not prevent or restrict rotation of the rotors to provide the maximum compression possible. Also, it is desirable to provide a multiple rotor rotary engine wherein the ends of the volume are sealed to contain the compressed fuel or air and it is desirable to make these sealing provisions as simple and durable as possible. It is also desirable to provide a multiple rotor rotary engine wherein the rotors are identical and interchangeable for maintenance purposes.

Prior art multiple rotor rotary engines are generally dedicated to one particular kind of fuel. It is desirable to provide a multiple rotor rotary engine that operates with a variety of different fuels including diesel fuel, and one which provides for the necessary compression required of a diesel engine.

Further, it is desirable to provide a highly efficient internal combustion engine that is operable in a self propelled electric vehicle to drive a motor/generator set that charges a battery pack. That is, the internal combustion engine, with multiple intermeshing lobes, does not drive the transmission or wheels of the vehicle, but rather just charges the battery pack which provides the motive force.

It is also highly desirable to provide an internal combustion engine that has efficiencies resulting from maximum compression and no wasted mechanical energy in the form of a mechanical linkage. In such an efficient engine, it is desirable to mechanically interconnect the output drive shaft and any accessories driven thereby. By mechanically coupling a power steering pump, air conditioning compressor, alternator, generator, or any other accessory to the main output shaft, a highly efficient solution is achieved in which no movement of the rotary engine is wasted. The whole assembly acts as a single flywheel.

In addition, it is desirable to provide a rotary internal combustion engine with a supplemental exhaust means to purge any combustion products remaining after the rotors pass the exhaust port. Directing air from an initial compression stage provided by a supercharger into the voids and around the rotors in a direction opposite to that of the rotors' rotation and back to the exhaust port provides such a supplemental exhaust means. The supplemental exhaust air is blown from the supercharger into the voids through purification pipes into the rotors' voids and around the rotors through bypass channels formed in the housing and, ultimately, out through the exhaust port.

An internal combustion engine having multiple rotors that form volumes in which fuel is efficiently captured, ignited, and the exhaust dispelled is desirable. The present invention provides such a highly efficient internal combustion engine with intermeshing lobes designed or on multiple rotors such that the seal of the volume between the rotors and lobes is virtually complete.

### OBJECTS OF THE INVENTION

It is an object of the present invention to provide a rotary internal combustion engine having efficient intermeshing rotors.

It is another object of the present invention to provide a rotary internal combustion engine having radial lobes on intermeshing rotors that conform to cooperating voids on adjacent intermeshing rotors.

It is yet another object of the present invention to provide a rotary internal combustion engine having two stage compression to allow operation as a diesel or non-diesel engine.

It is a further object of the present invention to provide a rotary internal combustion engine with two stage exhaust means to expel combustion products therefrom.

It is a further object of the present invention to provide a rotary internal combustion engine that is the motive force to drive a battery charging circuit for and electric drive vehicle.

It is yet another object of the present invention to provide a rotary internal combustion engine having at least two intermeshing rotors each having six alternating lobes and six alternating voids wherein the lobes are bulbous extensions and the voids are semicircular and of almost the almost diameter as the bulbous semicircular extension.

It is a further object of the present invention to provide a rotary internal combustion engine wherein intermeshing rotors create a volume of fuel or air or both, then compresses the fuel and combusts it to drive the rotors.

These and other objects and advantages of the present invention will be apparent from a review of the following specification and accompanying drawings.

### SUMMARY OF THE INVENTION

The present invention is a multiple rotor rotary engine having at least two intermeshing rotors mounted on parallel shafts in a housing. The rotors are identical and are designed with six radial lobes and six radial voids, with bevel ends formed at the end of the six radial lobes on each rotor. The radial lobes extend outwardly from the center of the rotors and have a bulbous beveled end. The voids are also formed with a semicircle shaped cross section of the same radius as the lobes such that the lobes fit precisely into the voids with little tolerance so that any a volume created between the rotors will be compressable. A fuel input means is provided as part of the rotary engine through which fuel is introduced into the housing, the fuel eventually being sealed in a volume between the rotors and compressed. A means for igniting combustion of the compressed fuel in the bevel chambers, with the fuel under maximum compression is provided, as well as a means for expelling combustion products as exhaust.

In the most preferred embodiment of the present invention, the fuel input means comprises fuel injectors positioned to introduce fuel into the volume in the bevel chamber under maximum compression. The intermeshing rotors are designed to cooperate to form a sealed volume during rotation, and specifically to compress the sealed volume into the bevel chambers.

In another preferred embodiment of the present invention, the multiple rotor rotary internal combustion engine has at least two intermeshing rotors mounted on parallel shafts in a housing, with six radial lobes and six radial voids on each rotor. The radial lobes having beveled ends are formed adjacent to the six radial voids on each rotor. An air input means through which air is introduced into said housing is provided, along with means for compressing air prior to introducing air into the housing. A means for injecting fuel into compressed air in the bevel chambers and a means for expelling combustion products as exhaust are also provided under this embodiment.

The multiple rotor rotary internal combustion engine has a fuel input means comprising fuel injectors positioned to introduce fuel into a volume under maximum compression.

The intermeshing rotors cooperate to form a sealed volume during rotation, and further compress the sealed volume into the bevel chambers.

In the most preferred embodiment of the present invention, the means for compressing air prior to introducing air into the housing comprises an externally mounted supercharger.

The multiple rotor rotary internal combustion engine of the present invention also provides means for expelling combustion products as exhaust, including purification pipes communicating pressurized air from the supercharger into radial voids to cyclically exhaust combustion products.

Another preferred embodiment of the present invention comprises a self propelled vehicle having an electric drive, wherein an electric drive circuit comprises a battery pack, an electrical control unit and a generator for charging a battery. A multiple fuel internal combustion engine for driving the generator to charge the battery pack is provided, the engine comprising multiple intermeshing rotors mounted on parallel shafts. Six radial lobes and six radial voids are formed on each said rotor, with compression volumes being formed between the radial lobes and the radial voids. Bevel chambers formed between the rotors are injected with fuel under maximum compression, and a fuel input means is provided through which fuel is introduced into notch compression volumes. A means for igniting combustion of the fuel is provided, as well as a means for expelling combustion products from the housing.

In the most preferred embodiment of the present invention, the fuel input means comprises fuel injectors positioned to introduce fuel into a volume under maximum compression and the intermeshing rotors cooperate to form a sealed volume during rotation. The self propelled vehicle having an electric drive incorporating intermeshing rotors further provides means for compressing the sealed volume into the bevel chambers.

The self propelled vehicle having an electric drive also has means for compressing air prior to introduction air into said housing comprising an externally mounted supercharger. Further, the self propelled vehicle having an electric drive of the present invention has supplemented the means for expelling combustion products as exhaust by providing purification pipes communicating pressurized air from the supercharger into radial voids in the rotors cyclically after exhaust of the combustion products, the supplemental expelling of air bypassing the rotors in the opposite direction through bypass channels provided in the housing.

### BRIEF DESCRIPTION OF THE DRAWINGS

FIG. 1 is a perspective view of the multiple rotor rotary engine within a housing with front end plate removed and with a supercharger attached for preliminary compression and to improve the exhaust of combustion products.

FIG. 2 is a top view of the multiple rotor rotary engine of the present invention showing the location of fuel injectors and sealed bearings.

FIG. 3 is a front view of the front end of the multiple rotor rotary engine illustrating the location of fuel injectors and sealed bearings.

FIG. 4 is a schematic representation of the use of the multiple rotor rotary engine within an electrical drive system for a vehicle.

FIG. 5 is a perspective view of the multiple rotor rotary engine within a housing with front end plate removed.

### DETAILED DESCRIPTION OF THE INVENTION

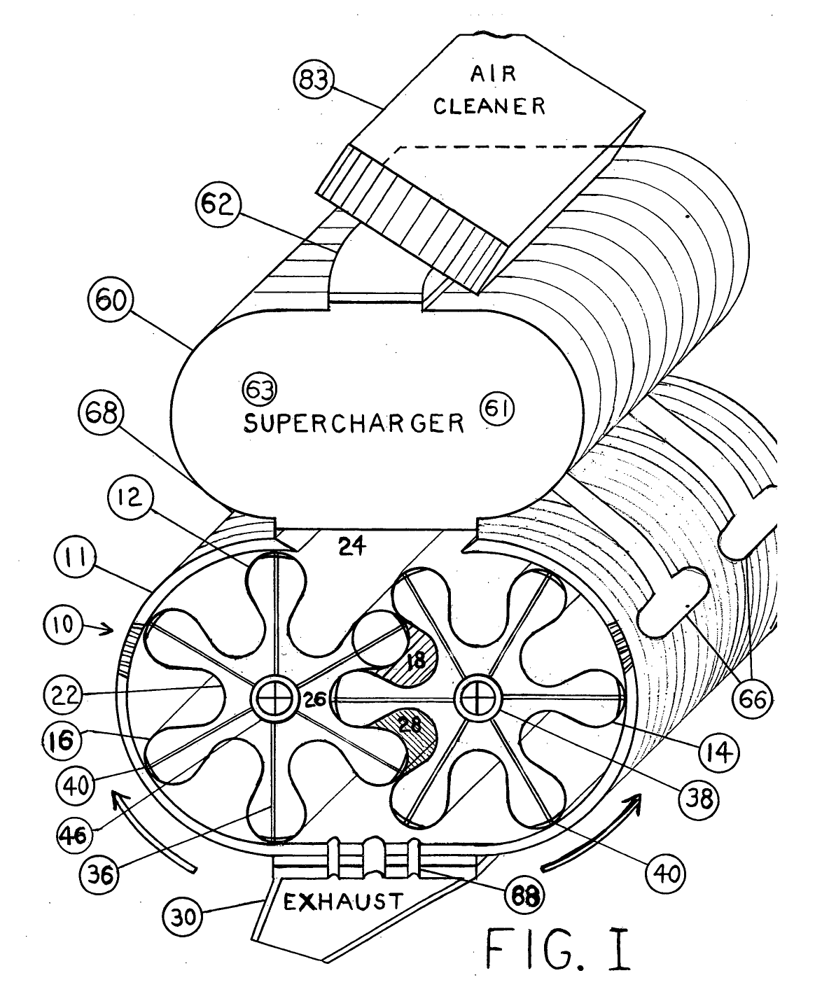

The present invention comprises a rotary engine 10 preferably having two identical rotors 12, 14 contained within a housing 11. The rotors 12, 14 are designed with intermeshing lobes 16 such that, as the rotors 12, 14 turn in the directions shown in FIG. 1 or FIG. 5, a sealed volume 18 is created, defined and sealed off by the rotors 12, 14 when the lobes come together at contact points 19, 21 as shown in FIG. 5. After sealing of the volume 18 at lobe contact points 19, 21, further rotation of the rotors 12, 14 results in the volume 18 being compressed by further rotation of the rotors 12, 14 until everything that was in volume 18 is compressed into the bevel chamber 26.

In a significant feature of the present invention, the rotors 12, 14 are designed with six identical radial lobes 16 on each rotor 12. The rotors 12, 14 also necessarily include six radial voids 22 between the lobes 16 and are defined by the size and shape of the lobes 16 except for a bevelled end at the most outwardly extending position.

The lobes 16 and voids 22 are ovoidal and complementary so that rotation of the rotors 12, 14 causes the lobe 16 to fit into and fill essentially the corresponding void 22 except for bevel chamber 26 (see FIGS. 1 and 5). As is evident from FIG. 5, as the rotors 12, 14 rotate, there are successive volumes 18 defined that are filled with fuel or air or both received from intake manifold 24. The intermeshing rotor contact at initial lobe meeting points 19, 21 prevent any escape of the volume 18 until later in the rotation (see lobe meeting points 23, 25 located just prior to release of the sealed volume 28). When maximum compression occurs and a lobe 16 is lined up within a void 22, the entire volume that had been in the void 18 has been compressed into the bevel chamber 26 (see FIG. 5). As will be described in more detail below, it is a significant feature of this invention that combustion occur at the point of maximum compression to maximize the efficiency of the power stroke and waste as little mechanical movement as possible.

After combustion of the compressed contents of bevel chamber 26, the rotation of the rotors 12, 14 create a volume 28 which expands and is filled with the expanded products of combustion from bevel chamber 26 (FIG. 5). Once the rotors 12, 14 have rotated so that the volume 28 is no longer sealed off, specifically when contact at points 23, 25 between the rotors 12, 14 is broken, the combustion products are initially exhausted out through the exhaust manifold 30. As will be explained in more detail herein, the supplemental means for exhausting combustion products is provided by introducing pressurized air into the voids 22 at a rotationally advanced position relative to the exhaust port. The pressurized air passes around the rotors 12, 14 in a direction opposite to rotation, through bypass channels 64, 65 formed in the housing 11, and ultimately out the exhaust manifold 30.

A restrictor plate 88 having perforations 89 is provided between the main chamber of the housing 11 and the exhaust manifold 30 to control the exhaust of all combustion products therethrough.

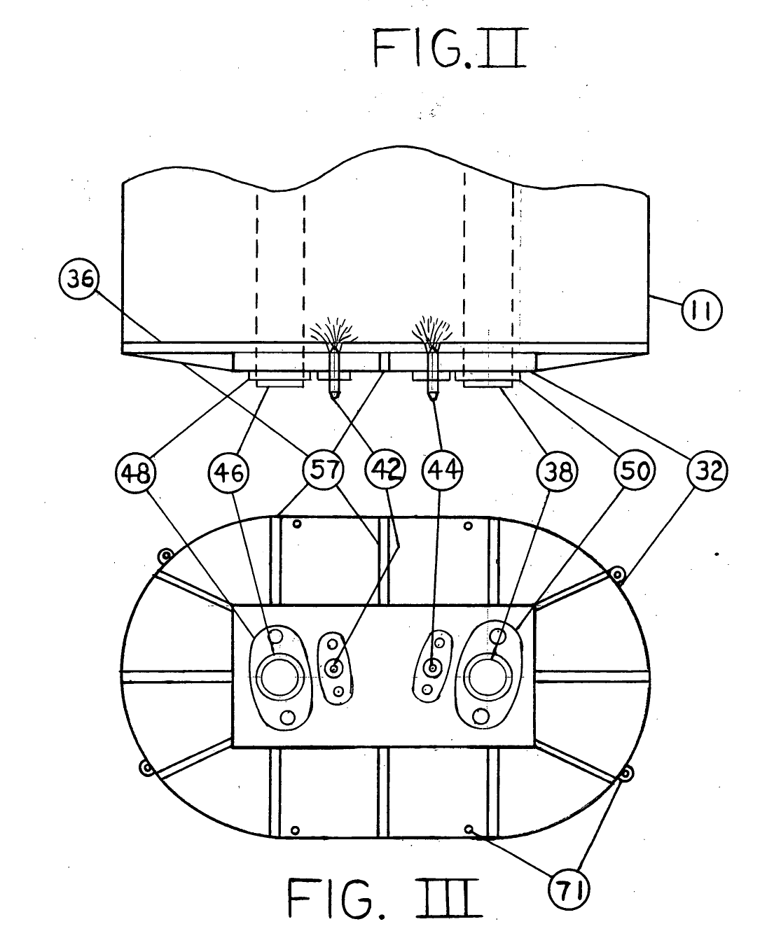

As is clear from FIG. 1, the geometric relationship between the six lobes 16 and voids 22 of the rotors 12, 14 provides volumes that are sealed off axially. The housing 11 includes a front plate 32 and rear plate 34 (see FIG. 2) which seal off the ends of the combustion volumes, each lobe 16 being provided with a sealing strip 36 that extends radially along the lobe 16 from the shaft 38 to the outer point 40 of the lobe 16. The sealing strip 36, along with the intermeshing lobes 16 and voids 22, define the volume 18 wherein fuel is compressed, ignited, expanded and exhausted.

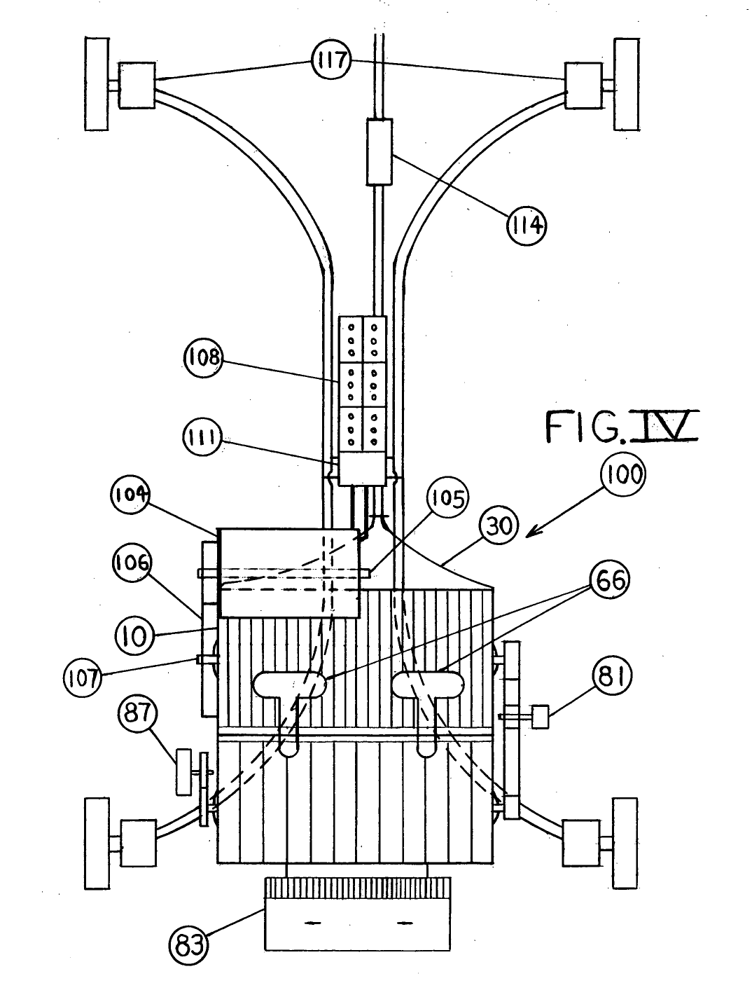

In a preferred embodiment of the present invention, the front plate 32 of the housing 11 is equipped with dual fuel injectors 42, 44 which inject fuel at the moment of maximum compression, when the rotors 12, 14 are perfectly aligned and all air and/or fuel is compressed into bevel chambers 26 as shown in FIGS. 2 and 3. Fuel is injected into the compressed volume in the bevel chamber 26 when the lobe 16 is fully contained in void 22 as shown in FIG. 5, the point of maximum compression. Because the volume has been compressed during rotation of the rotors to go from volume 18, at contact points 19, 21 between the rotors 12, 14 into a much smaller volume defined by notch 26, the compressed contents are heated so that fuel introduced therein immediately combusts.

The compression characteristics of this arrangement, between the initial compression provided by the supercharger 60 and the subsequent compression between intermeshing rotors 12, 14 allow the fuel and/or air to be compressed up to a 20:1 ratio, allowing the engine of the present invention to be used with virtually any kind of combustible fuel, including diesel, which requires a relatively high compression ratio of 20:1.

The rotors 12, 14 are mounted within the housing 11 on shafts 46, 38 and are received and free to rotate in sealed bearings 48, 50 mounted in the front plate 32 (FIG. 3), and sealed bearings 52, 54 in the rear plate 34. In a particularly advantageous aspect of the present invention, the shafts 46, 38 provide ventilation for the engine with cooling fins 91, 93 to allow air to be circulated therethrough to keep the rotors 12, 14 and other engine components cool during operation.

In a preferred embodiment of the present invention, the rotary engine 10 is designed to operate at maximum efficiency and even as a diesel engine by including a preliminary compression supercharger 60 that is mounted on top of the housing 11 (see FIG. 1). Rotation of the rotors 61, 63 in the supercharger 60 pulls air in through an air cleaner 83 and upper manifold 62 and compresses it to provide it through manifold 24 to the rotors 12, 14 already compressed. In this way, the necessary compression of 20:1 for diesel engines may be achieved by further compressing the volume 18 into bevel chamber 26. That is, in the preferred embodiment of the present invention utilizing a supercharger 60, the steps leading up and following combustion are: first, air is drawn in through a preliminary compression supercharger 60 and compressed therein. Next, the compressed air is taken in by the rotors 12, 14 and further compressed into bevel chamber 26. At full compression, when the volume 18 has been reduced to the smaller volume defined by bevel chamber 26, fuel is injected into the compressed volume and combustion occurs, driving the rotors 12, 14 in opposite directions. The products of combustion are then initially expelled through a restrictor plate 88 and out an exhaust duct 30. As the rotors 12, 14 continue to rotate, the voids 22 are hit with a supplemental means to expel the combustion products from the voids 22. Specifically, a burst of air from the supercharger 60 is communicated through purification pipes 66, 68 into the voids 22 at a rotationally advanced position relative to the exhaust manifold 30 to expel any remaining combustion products. The supercharger 60 thus has the additional function of providing purification assistance to the housing 11 because, in addition to sending compressed air to the top of the engine housing 11, it also sends air through purification pipes 66, 68 to blow out any combustion products that remain after the rotors pass the bottom exhaust manifold 30. Air directly from the supercharger 60 is injected into the voids 22 as shown in FIG. 5, which then bypasses the rotors 12, 14 in the opposite direction through bypass channels 64, 65. The supplemental expulsion air is then pushed out through the restrictor plate 88 and out the exhaust manifold 30, as shown in FIG. 5.

The sequence of steps in the method of operating an internal combustion engine in accordance with the principles of the present invention comprise the following: first, air is drawn in through an intake means, an intake manifold 24 and fills up a volume 18. The volume 18 is then sealed off and compressed by the rotation of the rotors 12, 14 until the air taken in through the intake manifold 24 is compressed into bevel chamber 26 in the rotors 12, 14. At full compression, when the volume 18 has been reduced to the smaller volume defined by bevel chamber 26, fuel is injected into the compressed volume by fuel injectors 42, 44 and combustion occurs, driving the rotors 12, 14 in the opposite directions. The products of combustion are then initially expelled through a restrictor plate 88 and out an exhaust duct 30. As the rotors 12, 14 continue to rotate, the voids 22 are hit with a supplemental expulsion means provided by a burst of air from the supercharger 60 communicated through purification pipes 66, 68 (FIG. 1) to expel remaining combustion products. The air from the supplemental expulsion means passes the rotors 12, 14 in the opposite direction through bypass channels 64, 65 and, eventually through the restrictor plate 88 and out the exhaust manifold 30.

In the most preferred embodiment of the present invention, the rotary engine 10 incorporating the principles herein with respect to dual rotors, is used exclusively to drive an alternator 104 of an electrically propelled vehicle 100.

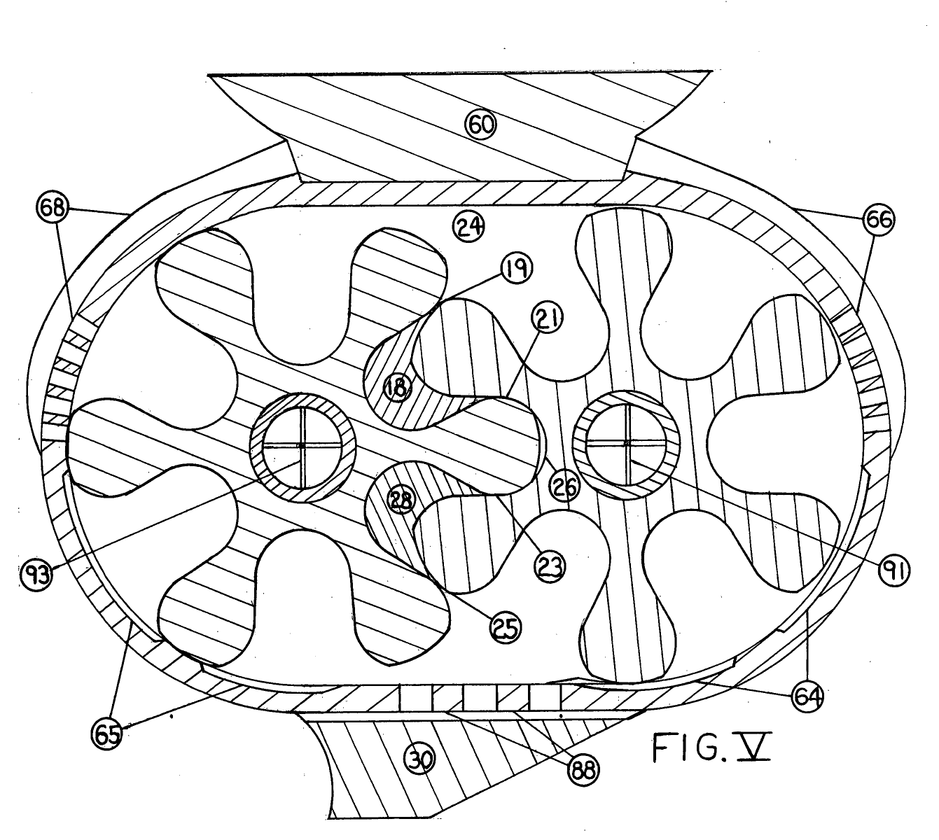

Specifically the internal combustion engine 10 of the present invention, having dual rotors 12, 14 and as further described above, is connected electrically to a motor/generator 104, as shown in FIG. 4. An output shaft from the engine 10 is mechanically coupled to the motor/generator 104 through gearbox 106. The motor/generator 104 is then electrically connected to an electrical control unit 111 which is connected to a battery pack 108.

Functionally, the motor/generator 104 initially acts as a starter for the internal combustion engine 10, receiving electrical power from the battery pack 108 to drive the mechanical output shaft 105 of the motor/generator 104, which then drives the shaft 107 of the internal combustion engine 10 (FIG. 4). Once started, the internal combustion engine 10 will operate to pull in air through the supercharger 60, compress it, and will then compress it further between the lobes 16 and voids 22 of the internal combustion engine 10, eventually being compressed into bevel chamber 26. At that point fuel is injected into the compressed volume and combustion occurs, as described above. Next, the combustion products are expelled, first through an exhaust manifold 30 when the sealed volume between the rotors 12, 14 is opened and then by a supplemental cleansing blast from the supercharger 60 through side mounted purification pipes 66, 68.

Once started, the internal combustion engine 10 drives its output shaft 107, to drive the motor/generator 104, which transmits electrical current to the electrical control unit 111. The electrical control unit then applies electrical power received from the motor/generator 104 to either charge the battery pack 108 or drive the electrical motors 117 that drive the wheels of the vehicle 100 (FIG. 4).

The mechanical output of the internal combustion engine 10 is also used to drive the other mechanical devices on the vehicle 10, such as the power steering pump 81, the air conditioning compressor 87, as well as other accessory devices. To maintain the efficiency, the engine 10 does not directly drive the wheels of the vehicle, although the output shaft from the engine 10 is mechanically coupled to any required accessories, such as a power steering unit, an alternator and an air conditioning compressor. It is advantageous and efficient to drive all such devices through a single mechanical linkage emulating one large flywheel.

The efficiency of the present multiple rotor internal combustion engine, with no wasted mechanical output, allows the internal combustion engine 10 to be utilized in this manner, as a battery charging device.

The electrical system of the vehicle 100 also includes provision for recapturing energy lost when applying the brakes. Specifically, motor/generators 117 are driven out of the electrical control unit 111 to drive the wheels, but when the car is in motion and the brakes are applied to slow it down, the motor/generator 117 act as generators to send current back to the electrical control unit 111 to assist in recharging the battery pack 108.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

I claim:

1. A multiple rotor rotary engine comprising:
at least two intermeshing rotors mounted on parallel shafts in a housing;
said rotors having six radial lobes having beveled ends and six radial voids;
bevel chambers formed between said intermeshing rotors;
fuel input means through which fuel is introduced into said housing;
means for igniting combustion in said bevel chambers; and
means for expelling combustion products as exhaust.

2. The rotary engine as set forth in claim 1 wherein said fuel input means comprises fuel injectors positioned to introduce fuel into a volume under maximum compression.

3. The rotary engine as set forth in claim 2 wherein said intermeshing rotors cooperate to form a sealed volume during rotation.

4. The rotary engine as set forth in claim 3 wherein said intermeshing rotors further compress said sealed volume into said bevel chambers.

5. A multiple rotor rotary internal combustion engine comprising:
at least two intermeshing rotors mounted on parallel shafts in a housing;
said rotors having six radial lobes and six radial voids;
bevel chambers formed between said intermeshing rotors;
air input means through which air is introduced into said housing;
means for compressing air prior to introducing air into said housing;
means for injecting fuel into compressed air in said bevel chambers; and
means for expelling combustion products as exhaust.

6. The multiple rotor rotary internal combustion engine set forth in claim 5 wherein said fuel input means comprises fuel injectors positioned to introduce fuel into a volume under maximum compression.

7. The multiple rotor rotary internal combustion engine set forth in claim 6 wherein said intermeshing rotors cooperate to form a sealed volume during rotation.

8. The multiple rotor rotary internal combustion engine set forth in claim 7 wherein said intermeshing rotors further compress said sealed volume into said bevel chambers.

9. The multiple rotor rotary internal combustion engine set forth in claim 5 wherein said means for compressing air prior to introducing air into said housing comprises an externally mounted supercharger.

10. The multiple rotor rotary internal combustion engine set forth in claim 9 wherein said means for expelling combustion products as exhaust comprise purification pipes communicating pressurized air from said supercharger in said radial voids cyclically after exhaust of said combustion products.

11. A self propelled vehicle having an electric drive comprising:
an electric drive circuit comprising a battery pack, an electrical control unit and a generator for charging said battery, said battery providing electric power to propel said vehicle;
a multiple fuel internal combustion engine for driving said generator as needed to charge said battery pack, said engine comprising:
multiple intermeshing rotors mounted on parallel shafts;
six radial lobes and six radial voids on each said rotor;
compression volumes formed between said radial lobes and said radial voids;
bevel chambers formed between said intermeshing rotors;
fuel input means through which fuel is introduced into said compression volumes;
means for igniting combustion of said fuel; and
means for expelling combustion products from said housing.

12. The self propelled vehicle having an electric drive set forth in claim 11 wherein said fuel input means comprises fuel injectors positioned to introduce fuel into a volume under maximum compression.

13. The self propelled vehicle having an electric drive set forth in claim 12 wherein said intermeshing rotors cooperate to form a sealed volume during rotation.

14. The self propelled vehicle having an electric drive set forth in claim 12 wherein said intermeshing rotors further compress said sealed volume into said bevel chambers.

15. The self propelled vehicle having an electric drive set forth in claim 11 wherein said means for compressing air prior to introducing air into said housing comprises an externally mounted supercharger.

16. The self propelled vehicle having an electric drive set forth in claim 14 wherein said means for expelling combustion products as exhaust comprise purification pipes communicating pressurized air from said supercharger in said radial voids cyclically after exhaust of said combustion products.
